(19) United States
(12) Patent Application Publication
(10) Pub. No.: US 2021/0047565 A1
(43) Pub. Date: Feb. 18, 2021

(54) COMPOSITION FOR A SPORTS SURFACE, IN PARTICULAR FOR AN EQUESTRIAN SPORT, AND METHOD FOR PRODUCING SUCH A COMPOSITION

(71) Applicant: COFORMEX, GENNES-VAL DE LOIRE (FR)

(72) Inventor: Patrick BELLIARD, TILQUES (FR)

(21) Appl. No.: 16/966,944

(22) PCT Filed: Feb. 12, 2019
(86) PCT No.: PCT/FR2019/050303

§ 371 Date: Aug. 3, 2020

(30) Foreign Application Priority Data
Feb. 14, 2018 (FR) 1851246

(51) Int. Cl. C09K 17/42; C04B 18/02; C04B 14/06; C04B 26/06; C04B 16/06; C04B 18/22; E01C 13/06

(52) U.S. Cl. CPC C09K 17/42; C04B 18/022; C04B 14/06; C04B 26/06; A63K 1/00; C04B 16/0633; C04B 18/22; E01C 13/065; C04B 16/0616

(57) ABSTRACT

The present invention relates to a composition for the production of a sports surface, especially for equestrian sports, advantageously comprising at least 50% by mass of sand, optionally at least one filler, and at most 10% by mass of an organic coating comprising at least one flexible polymer A having a tensile modulus less than or equal to 1 MPa at room temperature, as well as a process for manufacturing such a composition.

### BACKGROUND OF THE INVENTION

The present invention relates to the technical field of sports surfaces, in particular for animal racing, especially for the practice of equestrian sports, as well as the process for manufacturing and/or refurbishing such surfaces.

Equestrian sport is an activity that is widely practiced in the world and requires surfaces that meet increasing performance requirements, adapting to the various equestrian disciplines (for example dressage, show jumping, eventing, driving, endurance, aerobatics, para-equestrian dressage, galloping races, trotting races, etc.).

A number of studies have been carried out using sensors placed on the animals to study the impact of the nature of the surfaces on the horses' body (in particular the constraints undergone during training and competitions) and on the resulting behavior of the horses. These studies have shown that the nature and condition of these surfaces have an impact on the comfort, and therefore the performance and health (risk of injury) of the horses.

There is therefore a need for surfaces that optimize sporting performance and improve the comfort of animals, in particular horses, while limiting the risk of injury.

There is also a demand for a surface that has cushioning and rebound properties, that does not generate too much dust and that is not too abrasive to the hooves. Said surface must also maintain its properties over a wide range of temperatures, in order to withstand winter and summer temperatures in both temperate and non-temperate countries.

For example, WO 2009/055623 A1 relates to an equestrian surface prepared by mixing sand, previously dried and heated to a temperature comprised between 120° C. and 160° C., with a polymer and optionally an oil to provide the necessary mobility to the mixture in order to avoid catching the horses' hooves on impact. Fillers, such as cut fibers, are then mixed with the sand and oil. The mixture is then cooled while being kept in motion to maintain its overall granular consistency. In this process, the polymer is mixed in a solid state with the sand, and melts on contact with the heated sand.

WO 2015/077376 A1 describes the manufacture of an equestrian surface by heating the sand to a temperature above the softening temperature of the organic coating to be applied and then applying this coating which melts on contact with the hot sand grains. The organic coating comprises a polyalphaolefin polymer (APAO), which is always in admixture with a wax or oil, and a coupling agent comprising a silane in order to improve the adhesion of the coating to the sand grains and thus the abrasion resistance thereof. The mass proportion of oil or wax is equal to or considerably higher than that of APAO. In Example 1, APAO represents less than 50% by mass of the organic coating, the remainder being mineral oil and silane.

These processes require the application of the coating while hot, with polymers in the molten state; as well as the need to further mix the surface while it cools to avoid the formation of amalgamated sandy blocks that are difficult to destroy. This process is difficult to implement and can only be carried out directly on site.

Moreover, as this process is complex to implement, the reproducibility of surface quality is subject to the hazards of the construction sites.

FR 2 707 298 A1 relates to an equestrian surface comprising sand and for coating: a synthetic resin combined with an oil. The synthetic resin is selected so as to respect a determined contact angle so that the surface has a good draining behavior, and to avoid the accumulation of rainwater. The mass proportion of oil is considerably higher than that of synthetic resin.

In addition, wax or oil behaves badly when the surface is subjected to significant temperature variations (surface too sticky or too hard), and tends to migrate off the coating and stagnate on the bottom of the track. The coating then loses its initial properties.

FR 2 470 782 A1 relates to a composition for a soil which is hard since it is resistant to compression and cracking comprising sand and an organic coating with a very high mass proportion. This surface is unsuitable for equestrian sports as the sand grains are not mobile.

WO 99/19567 relates to an equestrian sports surface which is factory-prepared in advance by spraying a wax in the molten state (about 120° C.) onto the particulate material to be coated while in motion.

The disadvantage of waxes, however, is that they harden at low temperatures as early as 10-15° C. and soften as early as 30° C. to liquefy at temperatures of the order of 70-80° C., thus creating hard or sticky surfaces, losing their cohesion and leading to higher and more numerous projections when the horses gallop. Furthermore, the partial melting of these oils and waxes generates risks of exuding products that are harmful to the environment.

U.S. Pat. No. 9,012,557 B1 relates to an equestrian sports surface obtained by mixing sand and fillers with a liquid cross-linkable silicone resin. The formed silicone polymer being cross-linked has the advantage that it is less sensitive to temperature variations. However, the preparation of the surface remains complex as it is necessary for the operator to perfectly control the quantities of PDMS, cross-linking agent and catalyst, which can be tricky when refurbishing a surface when the application is carried out on site. In addition, silicone polymers are expensive. Finally, for new surfaces based on this process, it is still necessary to add oils or waxes to give the surface the required mobility, flexibility and allow the incorporation of the reagents to form the silicone polymer on dry ingredients.

The present invention thus relates to a composition for the preparation of a sports surface, in particular for animals, especially horses, improved in terms of mobility, flexibility, reduction of dust generated, resistant to temperature variations, not generating, or at least limiting the use of products harmful to the environment.

The present invention also relates to a process for manufacturing such a composition, which is easy to implement and easily reproducible, requiring limited equipment for perfectly controlled factory production.

### SUBJECT MATTER AND SUMMARY OF THE INVENTION

In the present text, a sports surface is understood to mean any surface for the practice of a sport, in particular one suitable for animals, especially for the practice of equestrian sport.

The present invention relates, according to a first aspect, to a composition for the production of a sports surface, especially for equestrian sports, advantageously comprising:
a. at least 50% by mass of sand;
b. optionally at least one filler;
c. at most 10% by mass, in particular at most 5% by mass, optionally at most 3% by mass, of an organic coating comprising at least one flexible polymer A having a tensile modulus less than or equal to 1 MPa at room temperature, preferably less than or equal to 0.70 MPa, still preferably less than or equal to 0.50 MPa, especially less than or equal to 0.40 MPa, said composition comprising no waxes or oils.

Advantageously, the use of a flexible polymer A at least partially coating the grains of sand, and optionally the other solid compound(s) present in the composition, such as the filler(s), gives the surface comprising said composition the properties of cushioning, rebound and comfort for the hooves of the horses. The grains of sand have good cohesion between them, thus limiting the generation of dust.

Advantageously, the composition comprises an organic coating in an amount that allows it to retain mobility between sand grains.

In the present text, tensile modulus is understood to mean Young's modulus, i.e. the constant connecting the tensile stress (MPa) and the onset of deformation (%) of the polymer A, in particular of an isotropic elastic material.

Tensile modulus (E) corresponds to the slope of the curve representing the stress (y-axis) versus the strain (x-axis) at the beginning of the elongation.

Tensile modulus can be measured using the standard NF ISO 527 parts 1 and 3, dated 1995, entitled “Determination of tensile properties—Test conditions for films and sheets”. Preferably the measurements are carried out in a room with a temperature of the order of 23° C. and a relative humidity of 50%, still preferably the tensile speed is 500 mm/minute.

Tensile modulus is a significant parameter of the polymer A in terms of its flexibility combined with its impact resistance behavior compared to consideration of its elongation at break alone (%).

Indeed, for a displacement of the sporting surface according to a given energy, if the tensile modulus is too high, the hoof does not move enough, which risks creating a greater impact for the horse. If the tensile modulus is low, the displacement of the surface is more important, which induces a less important shock, less traumatic, at the moment of impact.

Preferably, the mass proportion in said polymer A in the organic coating is greater than or equal to 50%, still preferably greater than or equal to 75%, preferentially greater than or equal to 90%.

Preferably, the mass proportion of water in the composition and/or in the organic coating is less than 10%, still preferably less than 5%, preferentially less than 3% (for example, ISO 3251:2008).

The mass proportions in the composition are defined as the dry mass of a given compound in relation to the total dry mass of said composition (once the water has evaporated).

Preferably, the weight-average molar mass Mw of the polymer A is greater than or equal to 10 000 g/mol, still preferably greater than or equal to 100 000 g/mol, in particular less than or equal to 800 000 g/mol, more particularly less than or equal to 500 000 g/mol, especially less than or equal to 300 000 g/mol.

The average molar mass Mw can be measured using standard NF T51-505 dated May 2011 titled “Plastics—Thermosetting resins—Analysis by size exclusion chromatography (G.P.C.)”, in particular in polystyrene equivalent.

Preferably, the sand is silica sand.

Preferably the mass-average particle size distribution D50 is less than or equal to 800 μm, more preferably less than or equal to 500 μm, preferentially less than or equal to 400 μm, in particular less than or equal to 300 μm, more preferably less than or equal to 250 μm.

Preferably, the mass-average particle size distribution D50 is greater than or equal to 50 μm, still preferably greater than or equal to 63 μm.

The mass-average particle size distribution can be measured with standard NF 11 507 dated December 1970 or with standard NF ISO 2591-1 dated September 1989 and titled “Control sieving—Operating modes using calibrated wire cloth and perforated metal sheet control sieves”.

Preferably, sand comprises a mass proportion of fines, i.e. particles with a size of less than 63 μm, less than or equal to 5%, still preferably less than or equal to 1%. This arrangement eliminates the generation of dust since the smallest and therefore most volatile particles are removed.

Preferably, the mass proportion of sand in the composition is greater than or equal to 60%, still preferably greater than or equal to 65%.

In an embodiment, the mass proportion of sand in the composition is less than or equal to 90%, optionally less than or equal to 80% or 70%.

In another embodiment, the mass proportion of sand in the composition is greater than or equal to 80%, in particular greater than or equal to 90%, more particularly greater than or equal to 95%.

The sand according to the invention may be washed or unwashed or be a mixture of washed and unwashed sand, in particular according to their origins. Washed sand reduces the amount of polymer A binder.

The composition may comprise one or more different fillers.

The one or more fillers are selected from fibers and/or granules in one or more natural and/or synthetic material(s), preferably recycled. Said material(s) is/are selected from the list consisting of: polypropylene, polyethylene, a chlorinated polymer (for example polyvinyl chloride or polybutylene chloride), polyurethane, polyamides (for example PA 6-6 or PA6), polyesters (for example PET (polyethylene terephthalate)), rubber, or a mixture thereof.

Preferably, the mass proportion of filler(s) in the composition is greater than or equal to 5%, optionally greater than or equal to 10% or 20% or 25%.

Preferably, the mass proportion of filler(s) in the composition is less than or equal to 40%, still preferably less than or equal to 35%, preferentially less than or equal to 30%, optionally less than or equal to 15%.

The one or more granules preferably have a size greater than or equal to 1 mm and less than or equal to 10 mm, still preferably less than or equal to 5 mm, preferentially greater than or equal to 3 mm.

The fibers preferably have a size greater than or equal to 10 mm, still preferably greater than or equal to 20 mm, preferentially less than or equal to 80 mm, in particular less than or equal to 60 mm, more particularly less than or equal to 50 mm.

The fibers contribute to the improvement of the cohesion of the composition, i.e. between the grains of sand, and to the reduction of projections during impacts on the sports surface.

In an embodiment, the composition comprises fillers selected from fibers, and is free of granules, in particular in at least one hydrophobic polymer material, such as a chlorinated polymer, for example PVC.

This type of composition is particularly sought after for indoor sports surfaces.

In another embodiment, the composition comprises fillers selected from fibers and granules, in particular granules in at least one hydrophobic polymer material, in particular a chlorinated polymer, for example PVC.

This type of composition is particularly sought after for outdoor sports surfaces, where the hydrophobicity of the granules improves the draining capacity of the composition.

Ambient temperature is understood in the present text to mean the temperature of the conditions of use of the composition according to the invention, in particular greater than or equal to −5° C. and less than or equal to 40° C., more particularly greater than or equal to 10° C. and less than or equal to 30° C. This ambient temperature is different from the ambient measurement temperature for the evaluation of mechanical properties (tensile modulus, elongation at break, etc.) comprised between 20° C. and 25° C.

One of the advantages of the present invention is that the composition retains its mobility without catching the horses' hooves on impact despite the absence of waxes or oils. Indeed, the polymer A provides sufficient flexibility and resistance to impact, thus eliminating the need to add waxes and/or oils.

The disadvantages of waxes and oils, particularly mineral waxes and oils, are that they harden at temperatures lower than or equal to 10° C. and liquefy or melt at temperatures higher than or equal to 40° C., thus generating mixtures that harden or, on the contrary, stick to the horses' hooves, which in both cases no longer provide the desired cushioning, rebound and mobility. In addition, waxes and oils migrate and settle on the bottom of the track. They therefore do not remain in the coating on the sand grains, which no longer fully ensures its initial properties.

Oil and/or wax is understood to mean any oil and/or wax of animal and/or vegetable and/or mineral and/or synthetic origin or a mixture thereof, preferably mineral.

Preferably, the composition does not comprise mineral waxes and/or mineral oils.

Oil is understood to mean any saturated or unsaturated fatty acid, or an oil, or any compound obtained by the use of at least 85%, in particular at least 90%, more particularly at least 95%, by mass of unsaturated or saturated fatty acid(s) or oil(s).

Wax is understood to mean any ester of long-chain acids (in particular at least 16 carbons) and alcohols which are also long-chain (in particular 16 or more carbons), optionally mixed with paraffin.

In a variant, the polymer A has a glass transition temperature of less than or equal to 10° C., preferably less than or equal to 0° C., still preferably less than or equal to −5° C., preferentially less than or equal to −8° C.

The polymer A preferably has a glass transition temperature Tg greater than or equal to −60° C., still preferably greater than or equal to −40° C.

The polymer A thus offers great flexibility at room temperature and therefore in the conditions of use of the composition, thus providing cushioning, rebound and improving the comfort of the animals.

Even when the ambient temperature is negative or below 10° C., the polymer A retains its flexibility and does not stiffen.

It has indeed been observed following compositional tests with a binder polymer A having a Tg of the order of 20° C., that the composition obtained is too rigid. The glass transition temperature is preferably measured by differential scanning calorimetry (DSC—according to standard ISO 11357-2 dating from 2013 with a temperature ramp of 10° C./min).

In a variant, the polymer A has an elongation at break of greater than or equal to 300%, preferably greater than or equal to 500%, still preferably greater than or equal to 700%, preferentially greater than or equal to 1000%.

The elongation at break (%) can be determined using the abovementioned standard NF ISO 527-1 and 3 of 1995.

This arrangement contributes to the flexibility of the polymer A.

In a variant, the polymer A, and optionally the organic coating, has a degradation temperature greater than or equal to 180° C.

Advantageously, the polymer A does not melt and does not liquefy at temperatures greater than or equal to 40° C. so that the composition does not stick to horses' hooves, for example, and does not generate potentially harmful products through exudation.

Advantageously, the polymer A has an amorphous structure so that it does not have a melting or softening temperature but a decomposition or degradation temperature, i.e. a temperature at which its mechanical properties are irreversibly degraded.

The particles of the composition retain their cohesion thus avoiding the generation of dust and projections in height during the gallop of the horses.

Preferably the polymer A and/or the organic coating has/have no melting temperature but only a decomposition temperature.

In a variant, the polymer A comprises repeat units derived from the polymerization of at least one monomer comprising (meth)acrylate and/or (meth)acrylic functions.

In a variant, the polymer A is selected from the list consisting of: a (meth)acrylic acid (co)polymer, a (co)polymer of (meth)acrylic acid and of a repeating unit comprising one or more aromatic ring(s), in particular styrene; an alkyl (meth)acrylate (co)polymer; such as butyl (meth)acrylate polymer or 2-ethyl-hexyl (meth)acrylate polymer; an alkyl (meth)acrylate-(meth)acrylic acid copolymer; a styrene-(meth)acrylic acid-alkyl (meth)acrylate copolymer, an acrylic acid-styrene copolymer, a (co)polymer of (meth)acrylate and fatty alcohol, a (co)polymer of (meth)acrylate and of poly-terpene derivatives, or a mixture thereof.

In the present text, “alkyl” is understood to mean any alkyl chain, linear and/or branched, unsaturated or not unsaturated, substituted or unsubstituted, comprising from one to fifteen carbon atoms, preferably from one to ten carbon atoms, still preferably from one to six carbon atoms, for example a methyl group, an ethyl group, an n-propyl group, an isopropyl group, an n-butyl group, an iso-butyl group, a sec-butyl group, a tert-butyl group, a 2-ethylhexyl group, or a mixture thereof. Fatty alcohol is understood in the present text to mean any carbon chain (preferably with an even carbon number) supporting at least one alcohol function, which may comprise a number of carbon atoms of up to 30 atoms, preferably primary alcohols, for example lauryl, stearyl. Preferably the number of carbon atoms is between 4 and 26, still preferably between 10 and 26.

The function of said alkyl chain is to provide flexibility to the polymer A.

In a variant, the composition comprises at least one polymer B selected from the list consisting of: polyisoprene, polyurethane, polysiloxane, polyacrylics, epoxyacrylates, poly-epoxy, polyesters, fluorinated polyacrylates, or a mixture thereof.

In a variant, the mass fraction of polymer B in said organic coating is less than or equal to 25%, preferably greater than or equal to 5%, still preferably greater than or equal to 10%.

In a variant, the mass-average particle size distribution D50 of the sand is greater than or equal to 63 μm.

In a variant, said at least one filler is selected from the list consisting of: synthetic fibers, plastic granules or rubber.

In an embodiment, the composition, in particular said at least one filler, does not comprise elastic fibers, for example elastane fibers.

Elastic fibers by definition have an elongation at break of more than 100%, notably more than 300%.

The present invention relates, according to a second aspect, to a process for manufacturing a composition for the production of a sports surface, in particular according to any one of the embodiments defined according to a first aspect of the invention, advantageously comprising:
a. mixing an aqueous emulsion of at least one polymer A with sand, said polymer A having a tensile modulus of less than or equal to 1 MPa at room temperature, and optionally at least one filler, so as to form a composition comprising at least 50% by mass of sand, and in particular not more than 10% by mass of said aqueous emulsion;
b. evaporating water from said composition;
c. obtaining a composition for the production of a sports surface, comprising at most 10% by mass of an organic coating comprising at least said polymer A, and not comprising waxes and oils.

Advantageously, it is not necessary to heat the sand so that it melts the organic mixture with which it comes into contact.

Similarly, it is not necessary to melt the organic mixture before applying it to the sand.

The aqueous emulsion is preferably applied at ambient temperature to the mixture of step a), in particular not previously heated, in order to coat the sand particles, and optionally the fillers. This provision facilitates the application of the polymer A either for the preparation of the composition at a place of manufacture distinct from the place of the sports surface, or for the preparation of the composition at the place of the sports surface (refurbishment or total replacement).

The water in the emulsion also promotes the coating of the mixture particles and thus the deposition of an organic coating.

Mixing can be done by projecting, for example by spraying, the aqueous emulsion onto the sand and then mixing the whole with a suitable tool, for example a ribbon blender in the factory or for example a Galopp Master classically used for the maintenance of tracks in case of refurbishment of old surfaces.

Preferably, the aqueous emulsion has a pH value greater than or equal to 6, and preferably greater than or equal to 7 (in particular measured using standard ISO 976 dated March 2014 “Rubber and plastics—Polymer dispersions and rubber latex—Determination of pH”).

Preferably, the aqueous emulsion has a viscosity greater than or equal to 100 mPa·s, still preferably greater than or equal to 400 mPa·s, in particular less than or equal to 5 000 mPa·s, more particularly less than or equal to 3 000 mPa·s. The viscosity is preferably measured at 23° C., using a Brookfield RVT viscometer, 20 rpm according to standard NF EN ISO 2555 dated September 1999 “Plastics—Resins in liquid state or in emulsions or dispersions—Determination of apparent viscosity according to the Brookfield process).

Preferably, the dry mass fraction of the aqueous emulsion according to the invention is greater than or equal to 20%, still preferably greater than or equal to 40%, in particular greater than or equal to 50%.

Preferably, the dry mass fraction of the aqueous emulsion according to the invention is less than or equal to 80%, preferably less than or equal to 70%.

The dry mass fraction of the aqueous emulsion comprising at least the polymer A is preferably determined at 105° C. and according to standard ISO 3251 dating from 2008 “Paints, varnishes and plastics—Determination of dry matter”.

The average particle size of the polymer A is preferably greater than or equal to 100 nm, still preferably greater than or equal to 200 nm, in particular less than or equal to 800 nm, more particularly less than or equal to 500 nm. The mean particle size can be measured using standard ISO 13321 dating from 1996 “Particle size analysis—Photon correlation spectroscopy”.

Following the application of the aqueous emulsion, and the evaporation of the water, an organic polymer-based coating is formed on all or part of the surface of the sand grains, and optionally the fillers.

Evaporation of the water can be obtained by any technique known to the person skilled in the art, and in particular by heating said composition for example to a temperature greater than or equal to 80° C., in particular less than or equal to 200° C., for at least 5 minutes, or by allowing the water to evaporate at ambient temperature for several hours.

In an embodiment, step b) of water evaporation involves passing the mixture from step a) through a fluidized-bed dryer.

The mixture is thus subjected to a flow of air and heated at the same time. The heating temperature is preferably greater than or equal to 70° C. and less than or equal to 120° C., in particular 100° C.

This drying technique advantageously forms a coating that at least partially coats each grain of sand, without binding the whole into a compact block. Indeed, without this drying technique, a compact block is formed, more or less flexible, which then needs to be decompacted to obtain the final composition which must have a good mobility of the sand grains among themselves, while having a certain cohesion.

In a preferred embodiment, the aqueous emulsion is mixed directly with the sand pre-mixed with the fillers.

In another embodiment, the aqueous emulsion is mixed with the sand and fillers present on the track to be refurbished.

The aqueous emulsion may comprise wetting agent(s) (for example polar group block copolymers) and/or UV stabilizer(s) (including benzotriazole family or other stabilizers conventionally used for coatings) to improve resistance to aging and/or biocidal additive(s) to reduce the development of microorganisms and/or additive(s) for adjusting the hydrophobicity of the organic coating and/or dye(s).

In a variant, the mixing of the aqueous emulsion of at least one polymer A with sand, and optionally at least one filler is carried out at ambient temperature.

The present invention relates, according to a third aspect, to a process for refurbishing a sports surface, in particular an equestrian sports surface, comprising a composition to be refurbished, said process advantageously comprising providing a composition according to any one of the variants defined with reference to the first aspect of the invention, or obtained according to any one of the variants defined with reference to the second aspect of the invention, as the main composition, and then mixing said composition to be refurbished with said main composition.

Preferably, the main composition represents at least 30% by mass of the total mass of the composition to be refurbished, still preferably at least 50% by mass, in particular at least 70% by mass.

The present invention relates, according to a fourth aspect, to a process for refurbishing a sports surface, especially for equestrian sports, comprising a composition to be refurbished comprising at least 50% by mass of sand, and optionally at least one filler, said process comprising:
providing an aqueous emulsion of at least one polymer A having a tensile modulus of less than or equal to 1 MPa at room temperature;
mixing said composition to be refurbished with said aqueous emulsion, in particular so as to form a composition comprising at most 10% by mass of said aqueous emulsion;
evaporating water from said composition;
obtaining a composition for the production of a sports surface, comprising at most 10% by mass of an organic coating comprising at least said polymer A, and not comprising waxes and oils.

Preferably, the mixing of the aqueous emulsion of at least one polymer A with sand and optionally at least one filler is carried out at ambient temperature.

The present invention relates, according to a fifth aspect, to a sports surface, especially for equestrian sports, advantageously comprising a composition according to any one of the variants defined with reference to a first aspect of the invention, or obtained according to any one of the variants defined with reference to a second and/or third and/or fourth aspect(s) of the invention.

The present invention relates, according to a sixth aspect, to the use of an aqueous emulsion comprising at least one polymer A having a tensile modulus less than or equal to 1 MPa at room temperature, for preparing a composition for the production of a sports surface, especially for equestrian sports, comprising at least 50% by mass of sand; optionally at least one filler; at most 10% by mass of an organic coating comprising at least said polymer A, and not comprising waxes and oils.

Said composition advantageously taking up any of the variants defined with reference to the first aspect of the invention.

The variants and definitions with reference to the first, second, third, fourth, fifth and sixth aspects can be combined independently of each other.

### DETAILED DESCRIPTION OF THE INVENTION

The present invention will be better understood by reading the example embodiments described below, cited in a non-limiting manner.

### Example 1

The composition comprises 67.45% by mass of silica sand with a grain size of 63 μm to 500 μm. The sand does not include any fines (size less than 63 μm) and has a mass-average particle size distribution D50 of about 198 μm. In addition, the composition comprises about 1.75% of a mixture of PP and PE fibers with lengths between 20 mm and 40 mm and about 27.90% by mass of PVC granules in the range of 3 mm to 5 mm. Finally, the composition comprises 2.90% by mass of an aqueous emulsion whose dry mass fraction is of the order of 60%. The polymer A is a copolymer of styrene, acrylic acid and butyl acrylate, whose Tg is of the order of −28° C. and the tensile or Young's modulus E is of the order of 0.2 MPa. The aqueous emulsion comprises 10% by mass (per to the total weight of the aqueous emulsion) of a wetting agent (for example Disperbyk P190). The elongation at break of the polymer A is of the order of 1100%. The sand, at ambient temperature (of the order of 20-25° C.) is first mixed with the PVC fibers and granules, then the aqueous emulsion, also at ambient temperature (of the order of 20-25° C.), is mixed with the pre-mixed sand and fillers. The mixture is dried so as to evaporate the water or left it at ambient temperature until the water evaporates. The mixture obtained is then emulsified again to destructure the agglomerates likely to form, at ambient temperature (around 20-25° C.) in order to form the final composition.

### Example 2

The composition comprises 68.31% by mass of silica sand with a grain size of 63 μm to 400 μm. The sand does not include fines (size less than 63 μm) and has a number-average distribution D50 of about 210 μm. The composition further comprises about 1.82% of a mixture of PP and PE fibers with lengths between 20 mm and 40 mm and about 27.32% by mass of PVC granules in the range of 3 mm to 5 mm. Finally, the composition comprises 2.55% by mass of an aqueous emulsion whose dry mass fraction is of the order of 60%. The polymer A is a copolymer of styrene, acrylic acid and butyl acrylate, whose Tg is of the order of −28° C. and the tensile or Young's modulus E is of the order of 0.2 MPa. The aqueous emulsion comprises 10% by mass (per to the total weight of the aqueous emulsion) of a wetting agent (for example Disperbyk P190). The elongation at break of the polymer A is of the order of 1100%. The sand, at ambient temperature (of the order of 20-25° C.) is first mixed with the PVC fibers and granules, then the aqueous emulsion, also at ambient temperature (of the order of 20-25° C.), is mixed with the pre-mixed sand and fillers. The mixture is dried so as to evaporate the water or left at room temperature until the water evaporates. The mixture obtained is then emulsified again to destructure the agglomerates likely to form, at ambient temperature (around 20-25° C.) so as to form the final composition with the desired granular aspect.

### Example 3

The composition comprises 87.49% by mass of silica sand with a grain size of 63 μm to 400 μm. The sand does not include fines (size less than 63 μm) and has a number-average distribution D50 of about 210 μm. The composition further comprises about 2.19% of a mixture of PP and PE fibers with lengths between 20 mm and 40 mm, and about 7.87% by mass of recycled and ground rubber granules of the order of 3 mm to 5 mm. Finally, the composition comprises 2.45% by mass of an aqueous emulsion whose dry mass fraction is of the order of 60%. The polymer A is a copolymer of styrene, acrylic acid and butyl acrylate, whose Tg is of the order of −28° C. and the tensile or Young's modulus E is of the order of 0.2 MPa. The aqueous emulsion comprises 10% by mass (per to the total weight of the aqueous emulsion) of a wetting agent (for example Disperbyk P190). The elongation at break of the polymer A is of the order of 1100%. The sand, at ambient temperature (of the order of 20-25° C.) is first mixed with the fibers and granules, then the aqueous emulsion, also at ambient temperature (of the order of 20-25° C.), is mixed with the pre-mixed sand and fillers. The mixture is dried so as to evaporate the water or left at room temperature until the water evaporates. The mixture obtained is then emulsified again to destructure the agglomerates likely to form, at ambient temperature (around 20-25° C.) so as to form the final composition with the desired granular aspect.

### Example 4

The composition comprises 96.44% by mass of silica sand with a grain size of 63 μm to 400 μm. The sand does not include fines (size less than 63 μm) and has a number-average distribution D50 of about 210 μm. In addition, the composition comprises approximately 1.92% of a mixture of PP and PE fibers with lengths between 20 mm and 40 mm (without PVC granules). Finally, the composition comprises 1.64% by mass of an aqueous emulsion with a dry mass fraction of the order of 60%. The polymer A is a copolymer of styrene and acrylic acid, whose Tg is of the order of −8° C. and the tensile or Young's modulus E is of the order of 0.4 MPa. The aqueous emulsion comprises 10% by mass (per to the total weight of the aqueous emulsion) of a wetting agent (for example Disperbyk P190). The elongation at break of the polymer A is of the order of 1100%. The sand, at ambient temperature (of the order of 20-25° C.) is first mixed with the fibers and then the aqueous emulsion, also at ambient temperature (of the order of 20-25° C.), is mixed with the sand and the pre-mixed fibers. The mixture is dried so as to evaporate the water or left at ambient temperature until the water evaporates. The mixture obtained is then broken up again to destructure the agglomerates that may form, at ambient temperature (around 20-25° C.) so as to form the final composition with the desired granular appearance.

The composition of Example 4 is intended for sports surfaces requiring less deformability.

The energy return (rebound), ground sinking (cohesion) and damping properties of the final composition according to Example 1) were evaluated in comparison with a control composition 1 comprising sand (about 85% by mass of the total mass of the final composition), wax with 20% mineral oil (about 5% by mass of the total mass of the final composition), fibers of lengths between 20 and 40 mm, and PVC granules (about 10% by mass of the total mass of the final composition).

The instrumented shock tests, with an energy of 117 joules (allowing the measurement of the deceleration on the ground of a mass in free fall, by accelerometric sensors, to determine the speed and movement of the mass, before and after impact, by successive integrations of the deceleration), carried out under conditions simulating the impact of horses, were performed on a sports surface comprising the different compositions according to the invention and a control composition, the latter having a thickness of 13 cm, and comprising a first layer 4 cm thick highly compacted with a 1500 g rammer, then a second layer 6 cm thick compacted less strongly than the first layer and a third finishing layer of about 3 cm slightly scratched to obtain the surface swelling.

### Return of Energy Transmitted During Hoof Impact in %.

TABLE 1

Temperature of the
composition

| | 9° C. | 17° C. | 29° C. | 40° C. |
|---|---|---|---|---|
| Composition | 20% | 15% | 11% | 11% |
| example 1 | | | | |
| Control | — | 11% | 9% | 8.3% |
| composition | | | | |

Ground Depression on Hoof Impact in Mm

TABLE 2

| | Temperature of the | | | | |
|---|---|---|---|---|---|
| | composition | | | | |
| | 9° C. | 17° C. | | 29° C. | 40° C. |
| Composition | 21.1 mm | 24.2 | mm | 29.6 mm | 30.1 mm |
| example 1 | | | | | |
| Control | — | 23 | mm | 31.7 mm | 40.4 mm |
| composition | | | | | |

Damping: Maximum Force Felt by the Horse (Newtons)

TABLE 3

Temperature of the
composition

| | 9° C. | 17° C. | 29° C. | 40° C. | |
|---|---|---|---|---|---|
| Composition | 8109 N | 7233 N | 6606 N | 6590 | n |
| example 1 | | | | | |
| Control | — | 6995 N | 6430 N | 5705 | N |
| composition | | | | | |

Shock Test Performed with a “Clegg Hammer” Device.

TABLE 4
Values of 60-70 Gm

| | Temperatures of the | | | | | | | | |
|---|---|---|---|---|---|---|---|---|---|
| | compositions tested (° C.) | | | | | | | | |
| | −5° C. | | 2.3° C. | | 14° C. | | 27° C. | 44° C. | 63° C. |
| Control | 170 | Gm | 118 | Gm | 110 | Gm | 64 Gm | 42 Gm | 37 Gm |
| Composition 2 | | | | | | | | | |
| Composition of | 80 | Gm | 57 | Gm | 55 | Gm | 56 Gm | 54 Gm | 41 Gm |
| Example 2 | | | | | | | | | |

The control composition 2 comprises sand (about 67.51% by mass of the total mass of the final composition), wax with 20% mineral oil (about 3.69% by mass of the total mass of the final composition), fibers of lengths between 20 and 40 mm (1.80% by mass of the total mass of the final composition), and PVC granules (about 27% by mass of the total mass of the final composition).

The “Clegg Hammer Test” is a device with a mass of 2500 g classically used to evaluate sports surfaces for animals. This device comprises an accelerometer to record the deceleration experienced at the moment of impact. This deceleration is expressed in Gm, which increases with the hardness of the material.

The composition according to Example 1 provides better energy return than the control composition. In addition, the composition according to Example 1 is less sensitive to temperature variations for ground sinking than the control composition, the amplitude of deformation between 9° C. and 40° C. is also lower (less than 10 mm variation for the composition according to Example 1 against almost 20 mm for the control composition). Finally, the composition according to Example 1 offers a damping of the same order as that offered by the control composition and this in a homogeneous manner from 9° C. to 40° C.

The composition according to Example 1 provides better elasticity. The sports surface with such a composition is easier to regain its position after impact. The energy return is higher than the values obtained for the control composition. The overall properties reflect a lower sensitivity of the composition in Example 1 to temperature with a lower deformation providing a less stressful and more constant contact for the horse.

Finally, the water permeability measured over a height of 10 cm of composition of Example 1 after compaction with a load of 1.5 MPa is 0.17 mm/sec, i.e. 612 mm of water per hour (value measured by monitoring the time necessary for migration, within a graduated cylinder, of a water height of 30 mm). This permeability value allows the composition of Example 1 to avoid water retention on the surface, thus ensuring a good draining effect.

### Comparative Example 5

A composition comprising 100 parts of silica sand having a sand grain size between 63 μm and 400 μm. The sand does not include fines (size less than 63 μm) and has a number-average distribution D50 of about 210 μm. In addition, the composition comprises about 1.8 parts of a mixture of PP and PE fibers with lengths between 20 mm and 40 mm (without PVC granules). Finally, the composition comprises 2.5 parts of an aqueous emulsion whose dry mass fraction is of the order of 50%. The polymer is a copolymer of styrene and acrylic acid, whose Tg is of the order of 4° C. and the tensile or Young's modulus E is of the order of 3.2 MPa (at 23° C.). The aqueous emulsion comprises 10% by mass (based on the total weight of the aqueous emulsion) of a wetting agent (for example Disperbyk P190).

### Examples 6 and 7

The compositions are identical to the composition in Comparative Example 5 with the difference that for Example 6, the polymer A is the same as in Example 1, and for Example 7, the polymer A is the same as in Example 4. In the internal cohesion test consisting of observing the state of the composition following a fall from a height of 40 cm of a ball compacted in said composition, it is observed that the loops are integral, without loss of cohesion between the sand and the fillers.

The compositions of Examples 6 and 7 give elastic surfaces with good mobility, with a satisfactory bond between the sand and the fibers so that the soil does not leak under the impact of the hooves. In comparison, the composition of Comparative Example 5 shows a strong separation between sand and fillers, making the surface unsuitable for use as it is much more leaking under the impact of the hooves. The cohesion between the sand and the loads is too weak. In the internal cohesion test, it is observed that the compacted ball is burst without cohesion between the sand and the loads.

Instrumented impact tests were performed on equestrian surfaces including the compositions of Examples 6 and 7. These tests involve the fall of a mass of 33 kg and developing an energy of 272 kJ with an angle of 12° with respect to the vertical of the tested surface. These tests simulate the impact of the horses' hooves on the surface. The results are reported in Table 5 and are in accordance with the recommendations of the sports federations.

TABLE 5

| | Example 6 | | | Example 7 | | |
|---|---|---|---|---|---|---|
| T° C. | 23° C. | 35° C. | 50° C. | 23° C. | 35° C. | 50° C. |
| Strike: damping capacity in kN | 5.77 | 12.49 | 11.5 | 14.6 | 13.6 | 12.6 |
| Response: energy return %. | 46 | 59 | 63 | 48 | 57 | 56 |
| Digging: firmness on contact in g | 120 | 84 | 69 | 95 | 83 | 77 |
| Leakage: hoof slippage in mm | 5.85 | 5.9 | 6.25 | 6.25 | 6.3 | 6.6 |

1-16. (canceled)

17. A composition, comprising:
at least 50% by mass of sand;
at most 10% by mass of an organic coating comprising at least one flexible polymer A having a tensile modulus less than or equal to 1 MPa at room temperature, and
wherein the composition does not comprise waxes and oils.

18. The composition according to claim 17, comprising at least one filler.

19. The composition according to claim 17, wherein the polymer A has a glass transition temperature of less than or equal to 10° C.

20. The composition according to claim 17, wherein the polymer A has an elongation at break of greater than or equal to 300%.

21. The composition according to claim 17, wherein the polymer A has a degradation temperature greater than or equal to 180° C.

22. The composition according to claim 17, wherein the polymer A comprises repeat units resulting from the polymerization of at least one monomer comprising (meth)acrylate and/or (meth)acrylic functions.

23. The composition according to claim 17, wherein the polymer A is selected from the list consisting of: a (meth)acrylic acid (co)polymer, (co)polymer of a (meth)acrylic acid and of a repeat unit comprising one or more aromatic ring(s), an alkyl (meth)acrylate (co)polymer; a styrene-(meth)acrylic acid-alkyl (meth)acrylate copolymer, a copolymer of (meth)acrylic acid and styrene, a (co)polymer of (meth)acrylate and fatty alcohol, a (co)polymer of (meth)acrylate and of poly-terpene derivatives, or a mixture thereof.

24. The composition according to claim 17, comprising at least one polymer B selected from the list consisting of: polyisoprene, polyurethane, polysiloxane, polyacrylics, epoxyacrylates, poly-epoxy, polyesters; fluorinated polyacrylates; or a mixture thereof.

25. The composition according to claim 17, wherein the number-average distribution D50 of the sand is greater than or equal to 63 μm.

26. The composition according to claim 18, wherein said at least one filler is selected from the list consisting of: synthetic fibers, plastic granules or rubber.

27. A process for manufacturing a composition for the production or refurbishing of a sports surface, comprising:
mixing an aqueous emulsion of at least one polymer A with sand, said polymer A having a tensile modulus less than or equal to 1 MPa at room temperature, so as to form a first composition comprising at least 50% by mass of sand and not comprising waxes and oils;
evaporating water from said first composition;
obtaining the composition for the production or refurbishing of the sports surface, the composition comprising at most 10% by mass of an organic coating comprising at least said polymer A.

28. The manufacturing process according to claim 27, wherein the at least aqueous emulsion of at least one polymer A is mixed with sand and at least one filler.

29. The manufacturing process according to claim 27, wherein the mixing of the aqueous emulsion of at least one polymer A with sand is carried out at ambient temperature.

30. The manufacturing process according to claim 27, wherein the evaporating of water comprises passing the first composition over a fluidized-bed drying apparatus.

31. The manufacturing processing according to claim 27, comprising mixing the composition with a composition to be refurbished comprised in the sports surface thereby refurbishing the sports surface.

32. A process for refurbishing a sports surface comprising a composition to be refurbished comprising at least 50% by mass of sand, said process comprising:
providing an aqueous emulsion of at least one polymer A having a tensile modulus of less than or equal to 1 MPa at room temperature;
mixing said composition to be refurbished with said aqueous emulsion;
evaporating water from the mixture; and
obtaining a composition comprising at least 50% by mass of sand for the production of the sports surface, comprising at most 10% by mass of an organic coating comprising at least said polymer A and not comprising waxes and oils.

33. The process according to claim 32, wherein the composition to be refurbished comprises at least one filler.

34. A sports surface comprising a composition according to claim 1.

35. A sports surface comprising a composition obtained using the process of claim 27.

36. A sports surface comprising a composition obtained using the process of claim 32.
